(19) United States
(12) Patent Application Publication
(10) Pub. No.: US 2016/0172687 A1
(43) Pub. Date: Jun. 16, 2016

(54) OXIDE-COATED METAL CATALYST FOR COMPOSITE ELECTRODE AND METHOD FOR PREPARING COMPOSITE ELECTRODE USING THE SAME

(71) Applicants: SNU R & DB Foundation, Seoul (KR); Global Frontier Center for Multiscale Energy Systems, Seoul (KR)

(72) Inventors: Ik Whang Chang, Daegu (KR); Suk Won Cha, Seoul (KR)

(73) Assignees: SNU R & DB Foundation; Global Frontier Center for Multiscale Energy Systems

(21) Appl. No.: 14/796,367

(22) Filed: Jul. 10, 2015

(30) Foreign Application Priority Data
Dec. 10, 2014 (KR) 10-2014-0177183

(51) Int. Cl. H01M 4/90; H01M 4/88; G01N 27/30; H01M 4/86

(52) U.S. Cl. CPC H01M 4/9058; H01M 4/8657; H01M 4/9025; H01M 4/881; H01M 4/8867; G01N 27/307; H01M 4/8871; H01M 4/8882

(57) ABSTRACT

Disclosed are an oxide-coated metal catalyst for a composite electrode and a method for preparing a composite electrode using the same. The metal catalyst includes oxide particles applied thereto, wherein the oxide particles are applied so as not to overlap one another or are applied as an independent separate layer, and the oxide particles are nanograins having a diameter of 1-500 nm. The oxide applied to the metal catalyst prevents the agglomeration of particles of the metal catalyst even under high-temperature conditions. Accordingly, the present invention overcomes the problem in which particles of a metal catalyst that is used in the anode or cathode of various fuel cells or in various electrode materials agglomerate when the metal catalyst particles reach high-temperature conditions during the fabrication or operation of the fuel cells, thereby reducing the efficiency of the electrode.

### CROSS-REFERENCE TO RELATED APPLICATION

This application claims under 35 U.S.C. §119(a) the benefit of Korean Application No. 10-2014-0177183 filed on Dec. 10, 2014, which is incorporated herein by reference.

### TECHNICAL FIELD

The present invention relates to an oxide-coated metal catalyst for a composite electrode and a method for preparing a composite electrode using the same.

### BACKGROUND ART

Fuel cells generate electrical power by a cell reaction in which water is produced from hydrogen and oxygen. In this case, hydrogen is produced by reacting a raw material, such as methanol, with water in the presence of a reforming catalyst. Such fuel cells can be classified into a polymer electrolyte membrane (PEM) type, a phosphoric acid type, a molten carbonate type, and a solid oxide type according to the type of electrolyte used. In addition, the operating temperatures of the fuel cells and the materials of components of the fuel cells vary depending on the type of electrolyte used.

Fuel cells are classified into various types as described above, and each fuel cell unit is generally composed of a membrane-electrode assembly (MEA) that includes an anode, a cathode, and a polymer electrolyte membrane interposed between the anode and the cathode. The anode includes a catalyst layer for promoting the oxidation of a fuel, and the cathode includes a catalyst layer for promoting the reduction of an oxidizing agent.

The catalyst layer included in each of the anode and the cathode includes a metal catalyst, and platinum (Pt) is most frequently used as the metal catalyst. However, platinum is costly. For this reason, research into the development of metal catalysts to be used as a substitute for platinum has been actively conducted. Palladium (Pd), ruthenium (Ru), silver and the like have also recently attracted attention as metal catalysts. Meanwhile, whether such metal catalysts have excellent activity has the greatest influence on the performance of electrodes included in various fuel cells.

However, various fuel cells or sensors can be fabricated only under high-temperature conditions in the fabrication process thereof. When such fuel cells or sensors are actually operated, the temperature thereof increases rapidly. In the fabrication or operating process in which the temperature increases rapidly, the agglomeration of particles of the metal catalyst occurs, thereby reducing the activity of the metal catalyst and also greatly reducing the efficiency of the electrode itself.

Documents related to the present invention include Korean Patent No. 10-1287891 (Patent Document 1). Patent Document 1 merely discloses a technology relating to a method for preparing a fuel cell catalyst having a large active surface area and excellent durability and electrical conductivity, but neither discloses nor suggests a technology for reducing the agglomeration of metal catalyst particles under high-temperature conditions. Furthermore, the effect of increasing the performance of a metal catalyst, as well as the reduction in agglomeration, is neither disclosed nor suggested in Patent Document 1.

### SUMMARY OF THE DISCLOSURE

Accordingly, the present invention has been made keeping in mind the above problems occurring in the prior art, and an object of the present invention is to provide a metal catalyst, the particles of which do not agglomerate even under high-temperature conditions.

Another object of the present invention is to provide a metal catalyst, the particles of which do not agglomerate even when being introduced into the anode or cathode of various fuel cells or the composite electrode of sensors or the like, so as to make it possible to maintain the efficiency of this anode, cathode or composite electrode in a desired state.

Still another object of the present invention is to provide a method for preparing a metal catalyst, the particles of which do not agglomerate even under high-temperature conditions.

Yet another object of the present invention is to provide a metal catalyst, the particles of which do not agglomerate even under high-temperature conditions and which also exhibits increased interfacial reactivity.

In accordance with an aspect of the present invention, there is provided a metal catalyst for a composite electrode, the metal catalyst including oxide particles applied thereto, wherein the oxide particles are applied so as not to overlap one another or are applied as an independent separate layer, and the oxide particles are nanograins having a diameter of 1-500 nm.

In accordance with another aspect of the present invention, there is provided a first method for preparing a composite electrode, the method comprising the steps of:

1) placing an electrode substrate including an electrolyte within a reaction chamber, and then disposing a metal catalyst on the electrode substrate;

2) introducing a precursor of an oxide into the reaction chamber to apply the oxide to the surface of the metal catalyst by deposition;

3) increasing the temperature of the reaction chamber after step 2); and

4) annealing the oxide applied to the surface of the metal catalyst while reducing the temperature of the reaction chamber to normal temperature, thereby converting the applied oxide into oxide particles;

wherein the oxide particles are nanograins having a diameter of 1-500 nm.

In accordance with still another aspect of the present invention, there is provided a second method for preparing a composite electrode, the method comprising the steps of:

1) placing an electrode substrate including an electrolyte within a reaction chamber, and then disposing a metal catalyst on the electrode substrate;

2) introducing a zirconium precursor into the reaction chamber to deposit zirconium on the metal catalyst;

3) introducing an yttrium precursor into the reaction chamber to deposit yttrium on the metal catalyst;

4) increasing the temperature of the reaction chamber, after performing steps 1) to 3) to apply yttrium-stabilized zirconium (YSZ) to the metal catalyst; and

5) annealing the YSZ applied to the metal catalyst while reducing the temperature of the reaction chamber to normal temperature, thereby converting the applied YSZ into YSZ particles.

### BRIEF DESCRIPTION OF THE DRAWINGS

The above and other objects, features and advantages of the present invention will be more clearly understood from the following detailed description taken in conjunction with the accompanying drawings, in which:

FIGS. 1A, 1B and 1C are schematic diagrams illustrating a preparation process used in Example 1;

FIGS. 2A and 2B show photographs showing the nanodot or core-shell structures formed from oxide (YSZ) particles after annealing;

FIGS. 3A and 3B show photographs showing oxide (YSZ) particles applied to a thickness of 1 nm (FIG. 3A) and a thickness of 2 nm (FIG. 3B) in Example 1;

FIGS. 4A and 4B show photographs showing oxide (YSZ) particles applied to a thickness of 3 nm (FIG. 4A) and a thickness of 5 nm (FIG. 3B) in Example 2;

FIGS. 5A and 5B show photographs showing oxide (YSZ) particles applied to a thickness of 1 nm (FIG. 5A) and a thickness of 2 nm (FIG. 5B) before annealing (FIG. 5A) and after annealing FIG. 5B) in Example 3;

FIGS. 6A and 6B show the results of measuring whether the agglomeration of particles of a metal catalyst of Comparative Example 1 (FIG. 6A) and a metal catalyst of Example 1 (FIG. 6B) occurred;

FIGS. 7A and 7B show photographs showing the severe agglomeration of particles of a pure platinum (Pt) catalyst, which occurred when a fuel cell including the catalyst was operated under high-temperature conditions;

FIGS. 8A and 8B show photographs showing the severe agglomeration of particles of a metal catalyst of Comparative Example 2, which occurred when a fuel cell including the catalyst was operated under high-temperature conditions;

FIG. 9 is a graph showing the results of analyzing the effect of oxide particle coating, performed in Example 4 and Example 5, on improvement in performance;

FIG. 10 is a graph showing the results of comparing cell performance between the case in which an electrode of Example 1 was used as a composite electrode and the case in which an electrode of Comparative Example 1 was used as a composite electrode; and

FIG. 11 is a graph showing the results of measuring the sheet resistances of composite electrodes prepared in Example 3 and Comparative Example 1.

### DETAILED DESCRIPTION OF THE DISCLOSURE

Hereinafter, embodiments of the present invention will be described in detail with reference to the accompanying drawings.

The present inventors have made extensive efforts to develop a metal catalyst for a composite electrode, the particles of which do not agglomerate even when the metal catalyst particles reach high temperatures during the fabrication or operation of various fuel cells. As a result, the present inventors have developed an oxide-coated metal catalyst for a composite electrode according to the present invention and a preparation method thereof, thereby completing the present invention.

More specifically, a metal catalyst for a composite electrode according to the present invention includes oxide particles applied thereto, wherein the oxide particles are applied so as not to overlap one another or are applied as an independent separate layer, and the oxide particles are nanograins having a diameter of 1-500 nm.

The metal catalyst for the composite electrode according to the present invention includes oxide particles applied to the surface thereof, and also has a structure that reduces the agglomeration of the metal catalyst particles, which occurs when the metal catalyst reaches high temperatures during the fabrication or operation of various fuel cells. The agglomeration of the metal catalyst particles is not only reduced, but other functions can be also improved. Among them, a new reaction area in a fuel cell is formed to further improve the function of the fuel cell.

To form the structure that reduces the agglomeration of the metal catalyst particles, the oxide particles are applied so as not to overlap one another or are applied as an independent separate layer. When the oxide particles are applied so as not to overlap one another or are applied as an independent separate layer, the oxide particles will not agglomerate, and the reactivity at the interface will be further increased while the form of a single layer is also possible. Meanwhile, in the prior art, some published documents relating to a technology of modifying a metal catalyst by coating it with an oxide material are present, but a published document relating to a structure obtained by uniformly applying oxide particles so as not to overlap one another or to form an independent separate layer or a single layer and a preparation method thereof, as disclosed in the present invention, is not present.

In addition, the oxide particles are applied to the metal catalyst while they have a very uniform size. Such oxide particles having a uniform size are nanograins having a diameter of 1-500 nm. Only the oxide particles that are nanograins having a size of 1-500 nm correspond to oxide particles having a uniform size, and exhibit the effect to be achieved by the present invention. Meanwhile, the term “nanograins” means grains having a nanometer size.

The oxide particles having a uniform size preferably have an average particle diameter of 1-10 nm. If the average particle diameter of the oxide particles is smaller than 1 nm, the oxide particles cannot prevent the agglomeration of the metal catalyst particles because the particle size is excessively small. If the average particle size of the oxide particles is larger than 10 nm, a fuel required for an electrode reaction cannot reach the reaction interface when the particles are applied as a complete single layer without overlapping one another.

Meanwhile, the oxide that is used in the present invention is not specifically limited as long as it can prevent the agglomeration of the metal catalyst particles. A ceramic oxide that may be used in the present invention is preferably one or more selected from the group consisting of yttrium oxide, scandium oxide, zirconia, gadolinium oxide, samarium oxide, lanthanum oxide, ytterbium oxide, neodymium oxide, ceria, strontium oxide, magnesium oxide, lanthanum gallate, barium zirconate, barium cerate, strontium cerate, strontium zirconate, and parent perovskite.

In addition, the metal of the metal catalyst is not specifically limited with the exception of platinum as long as it can be used as a metal catalyst in an electrode for various fuel cells or a composite electrode for sensors. Preferably, the metal of the metal catalyst is one or more selected from the group consisting of palladium, ruthenium, cobalt, iron, lithium, magnesium, copper, zinc, silver, rhodium, molybdenum, lanthanum, titanium, tin, vanadium, chromium, manganese, nickel, aluminum, antimony, arsenic, barium, bismuth, calcium, lead, mercury, silicon, tantalum, and oxides of these metals. More specifically, the reason why platinum is excluded is that the agglomeration preventing effect achieved by the use of platinum is significantly inferior to those achieved by the use of the above-listed metals. Thus, when the oxide particles are applied to the metal catalyst to form the above-described structure, they will exhibit the effect of significantly reducing the agglomeration of the metal catalyst particles even when the metal catalyst reaches high temperatures during the fabrication or operation of fuel cells or the like. In addition, the reactivity of the metal catalyst will be further improved.

A first method for preparing a composite electrode according to another aspect of the present invention includes the steps of:

1) placing an electrode substrate including an electrolyte within a reaction chamber, and then disposing a metal catalyst on the electrode substrate;

2) introducing a precursor of an oxide into the reaction chamber to apply the oxide to the surface of the metal catalyst by deposition;

3) increasing the temperature of the reaction chamber after step 2); and

4) annealing the oxide applied to the surface of the metal catalyst while reducing the temperature of the reaction chamber to normal temperature, thereby converting the applied oxide into oxide particles;

wherein the oxide particles are nanograins having a diameter of 1-500 nm.

When a composite electrode is prepared by the preparation method according to the present invention, the agglomeration of metal catalyst particles in the prepared composite electrode can be prevented even under high-temperature conditions. In addition, the reactivity at the interface is also improved to a desired level.

The electrolyte that is used in the present invention is not specifically limited as long as it is used as an electrolyte for various fuel cells or sensors.

Further, the electrode substrate that is used in the present invention may be any known electrode substrate that is used as an electrode substrate for a composite electrode.

Meanwhile, the reaction chamber is preferably operated at an initial temperature of 150 to 350° C. in order to convert the applied oxide into oxide particles.

In addition, the metal of the metal catalyst is not specifically limited with the exception of platinum as long as it can be used as a metal catalyst in an electrode for various fuel cells or a composite electrode for sensors. Preferably, the metal of the metal catalyst is one or more selected from the group consisting of palladium, ruthenium, cobalt, iron, lithium, magnesium, copper, zinc, silver, rhodium, molybdenum, lanthanum, titanium, tin, vanadium, chromium, manganese, nickel, aluminum, antimony, arsenic, barium, bismuth, calcium, lead, mercury, silicon, tantalum, and oxides of these metals.

Meanwhile, the oxide that is deposited in step 2) is not specifically limited as long as it is an oxide material capable of preventing the agglomeration of the metal catalyst particles. A ceramic oxide that may be used in the present invention is preferably one or more selected from the group consisting of yttrium oxide, scandium oxide, zirconia, gadolinium oxide, samarium oxide, lanthanum oxide, ytterbium oxide, neodymium oxide, ceria, strontium oxide, magnesium oxide, lanthanum gallate, barium zirconate, barium cerate, strontium cerate, strontium zirconate, and parent perovskite. In addition, the oxide may also be a metal oxide, and the metal oxide is preferably one or more selected from the group consisting of aluminum, antimony, arsenic, barium, bismuth, calcium, chromium, cobalt, copper, iron, lead, lithium, manganese, mercury, nickel, silicon, tantalum, tin and zinc oxides.

Meanwhile, in step 2), the oxide is preferably applied to a minimum thickness so as to be able to prevent the agglomeration of the metal catalyst particles. Preferably, the oxide may be applied to a thickness of 1-500 nm.

Meanwhile, since the oxide should be applied to a minimum thickness in step 2), the oxide particles are applied without overlapping one another. In addition, the oxide is preferably applied as a single layer or applied to a uniform thickness.

In addition, the deposition in step 2) is preferably performed at a temperature of 150 to 350° C. because this temperature is a temperature suitable for application of the oxide.

After the oxide has been applied to the metal catalyst in step 2), a process of converting the applied oxide into nano-scale electrode structures is required. To perform this process, a process of increasing the temperature of the reaction chamber to a high temperature in step 3) may be performed. The high temperature that is achieved in step 3) is preferably between 200° C. and 800° C. In addition, the temperature of the reaction chamber is preferably increased to a high temperature at a rate of 0.1 to 50° C./min. When the temperature is increased to the above temperature at the above rate, the oxide applied to the surface will be converted into nanodots. The term “nanodots” refers to structures resulting from the conversion of the applied oxide from a planar form to the form of nanosized particles (nanoparticles or oxide particles). After the temperature has been increased to a temperature between 200° C. and 800° C., the increased temperature is preferably maintained for 1-50 hours. When the increased temperature is maintained for 1-50 hours after the temperature has been increased to the above temperature range at the above rate, the oxide applied to the surface will be converted into uniform nanodot or core-shell structures. The term “core-shell structures” refers to core structures formed by the conversion of the applied oxide from a planar form to the form of nanosized particles, like the nanodot structures.

After the above-described processes have been performed, an annealing process is performed while the temperature of the reaction chamber is reduced to normal temperature. As used herein, the term “normal temperature” preferably means ambient temperature during the reaction. In an embodiment, normal temperature may be 25° C. In addition, the rate at which the temperature is reduced to normal temperature is not specifically limited. Moreover, because the oxide applied to the surface is converted into nanodot or core-shell structures that are in the form of oxide nanoparticles, the oxide particles are applied to the metal catalyst without overlapping one another, thereby forming single-layer nanodot or core-shell structures which effectively prevent the agglomeration of the metal catalyst particles at high temperatures. In addition, when the oxide applied to the surface is converted into oxide nanoparticles, as disclosed in the present invention, the coating thickness of the oxide particles can be minimized to a very small thickness.

The average particle size of the oxide particles is preferably 1-10 nm, and the oxide particles are applied to the metal catalyst while they have a uniform size. More specifically, the applied oxide particles are nanograins having a diameter of 1-500 nm while they have an average particle size of 1-10 nm. Thus, the oxide particles are applied to the metal catalyst while they have a uniform size.

Meanwhile, the deposition process that is used in the present invention is not specifically limited. Preferably, it may be a deposition process, such as chemical vapor deposition (CVD), atomic layer deposition (ALD) or sputtering. More preferably, any deposition process may be used without particular limitation as long as it can deposit oxide particles with a size of less than 10 nm.

When the composite electrode is prepared by the preparation method according to the present invention, the oxide particles can be applied as a single layer on the surface of the metal catalyst without overlapping one another, and can also be applied to a minimum thickness. Thus, the metal catalyst particles can be prevented from agglomerating during the preparation of the composite electrode or the operation of various fuel cells, so that the resulting composite electrode can exhibit desired efficiency.

A second method for preparing a composite electrode according to still another aspect of the present invention includes the steps of:

1) placing an electrode substrate including an electrolyte within a reaction chamber, and then disposing a metal catalyst on the electrode substrate;

2) introducing a zirconium precursor into the reaction chamber to deposit zirconium on the metal catalyst;

3) introducing an yttrium precursor into the reaction chamber to deposit yttrium on the metal catalyst;

4) increasing the temperature of the reaction chamber, after performing steps 1) to 3) to apply yttrium-stabilized zirconium (YSZ) to the metal catalyst; and

5) annealing the YSZ applied to the metal catalyst while reducing the temperature of the reaction chamber to normal temperature, thereby converting the applied YSZ into YSZ particles.

More specifically, the second method for preparing the composite electrode according to the present invention differs from the first preparation method in that YSZ applied to the metal catalyst by deposition of zirconium and yttrium is converted into YSZ particles.

The initial temperature of the reaction chamber is preferably between 150° C. and 250° C., and deposition of zirconium in step 2) may preferably be performed at a temperature between 150° C. and 250° C. In addition, deposition of yttrium in step 3) may preferably be performed at a temperature between 150° C. and 800° C. As used herein, the term “normal temperature” preferably means ambient temperature during the reaction. In an embodiment, normal temperature may be 25° C. In addition, the rate at which the temperature is reduced to normal temperature is not specifically limited. When steps 1) to 4) are performed, YSZ is formed and applied to the surface of the metal catalyst to a very thin and uniform thickness. This coating thickness may be 1-10 nm.

Meanwhile, the number of deposition of zirconium in step 2) and the number of deposition of yttrium in step 3) are not specifically limited. In a preferred embodiment, the ratio of the number of deposition of zirconium in step 2) to the number of deposition of yttrium in step 3) may be 1:1 to 1:10 (number of deposition of zirconium: number of deposition of yttrium).

Hereinafter, the present invention will be described in detail with reference to preferred examples so that those skilled in the art can easily carry out the present invention. However, the present invention can be embodied in various different forms, and are not limited to the examples described herein.

### EXAMPLES

### Example 1

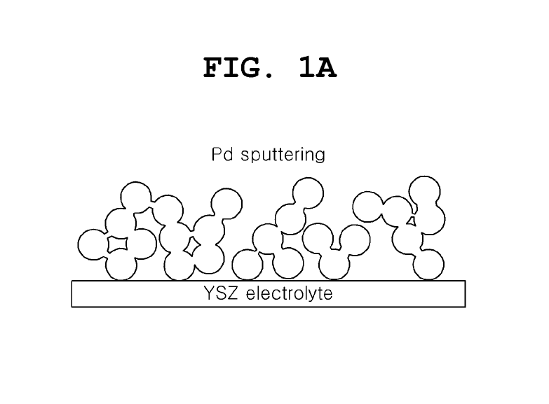

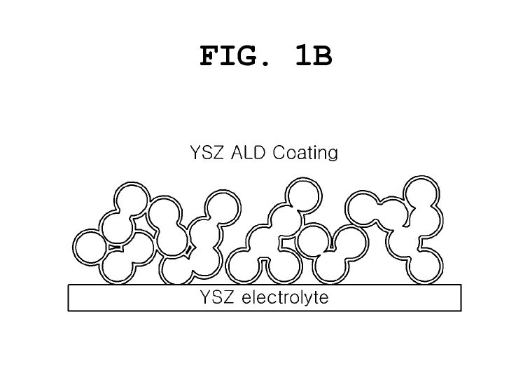

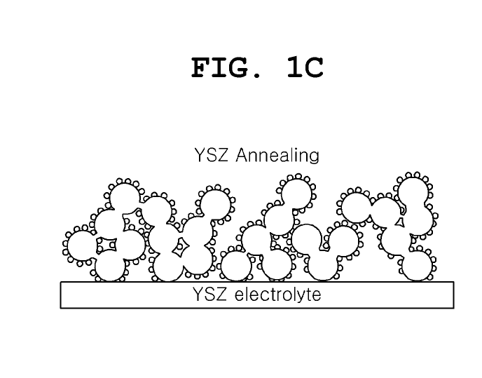

As an electrode substrate, porous aluminum oxide having palladium deposited thereon was used. Also, yttrium-stabilized zirconium (YSZ) was used as an electrolyte on the electrode substrate. The electrode substrate covered with the electrolyte was placed in a reaction chamber (atomic layer deposition (ALD) chamber). As a metal catalyst, a palladium catalyst was deposited on the electrolyte by introducing it into the reaction chamber through a sputter (Atech Inc., Korea). The deposition of the palladium catalyst was performed using argon gas under a pressure of 90 mtorr. Next, a deposition process for applying YSZ to the surface of the palladium catalyst was performed. More specifically, a zirconium precursor was introduced into the reaction chamber to deposit zirconium, and then an yttrium precursor was introduced into the reaction chamber to deposit yttrium. The zirconium precursor and yttrium precursor used were tetrakis(dimethylamino)zirconium (Zr(NMe₂)₄) and tris(methylcyclopentadienyl)yttrium (Y(MeCp)₃), respectively. The ALD sequence was set as follows: for zirconium, precursor pulse for 3 sec, Ar purging for 20 sec, oxygen pulse for 4 sec, and Ar purging for 10 sec; and for yttrium, precursor pulse for 3 sec, Ar purging for 20 sec, oxygen pulse for 1 sec, and Ar purging for 10 sec. In addition, the deposition process was performed under the conditions set as follows: an ALD chamber temperature of 250° C.; an yttrium precursor temperature of 155° C.; an yttrium line temperature of 180° C.; a zirconium precursor temperature of 40° C.; and a zirconium line temperature of 65° C. Also, during the deposition process, the ratio of zirconium cycles to yttrium cycles was 7:1. Through this deposition process, YSZ was applied to the surface of palladium metal catalyst to a thickness of 5 nm. After the completion of this deposition process, the temperature of the reaction chamber was increased to 500° C. at a rate of 10° C./min, and then maintained at that temperature for 2 hours. After the reaction chamber had been maintained at 500° C. for 2 hours, annealing was performed while the temperature of the reaction chamber was naturally reduced to normal temperature (about 25° C.). Through this annealing process, the oxide coating layer was converted into oxide particles. As a result, a composite electrode including the oxide particles applied to the surface of the palladium metal catalyst was prepared. FIGS. 1A, 1B and 1C schematically show the process of Example 1. Meanwhile, the surface of the composite electrode including the oxide particles applied to the surface of the palladium catalyst was analyzed using an electron microscope (Carl Zeiss, Germany). The results of the analysis indicated that the oxide particles had an average particle size of about 5 nm.

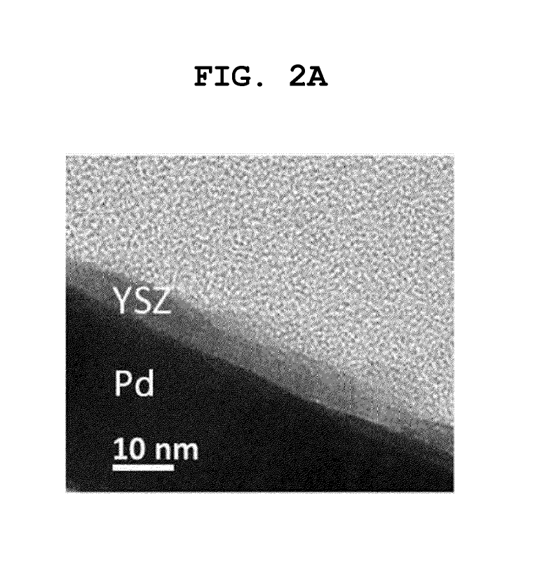

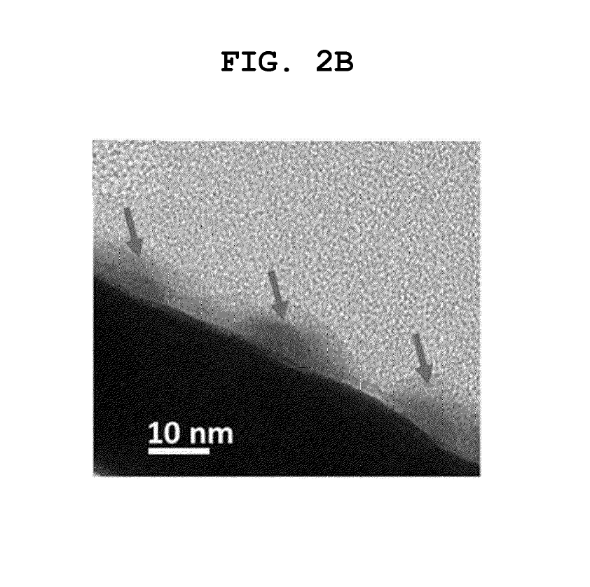

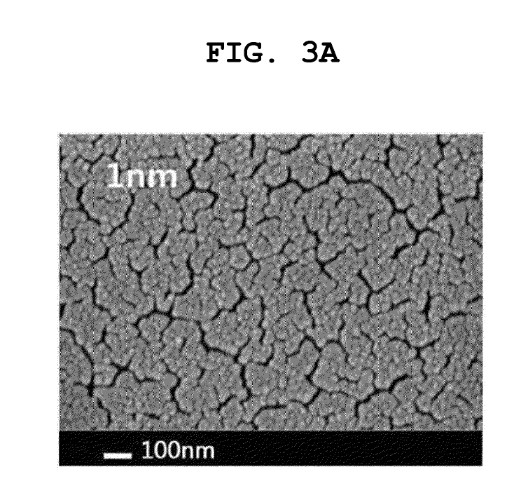

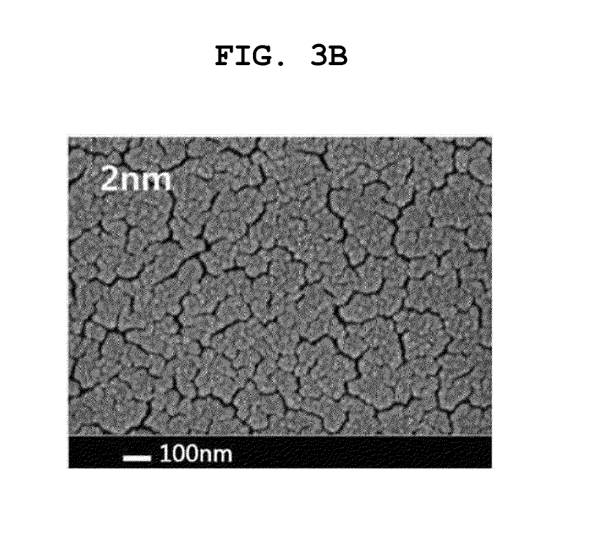

FIGS. 1A, 1B and 1C schematically show the process of Example 1. Also, FIGS. 2A and 2B show photographs showing nanodot or core-shell structures formed from the oxide (YSZ) particles after annealing (FIG. 2A: before annealing; FIG. 2B: after annealing). In addition, FIGS. 3A and 3B are photographs showing the oxide (YSZ) particles applied to a thickness of 1 nm (FIG. 3A) and a thickness of 2 nm (FIG. 3B) in Example 1.

### Example 2

A composite electrode including a metal catalyst coated with oxide particles was prepared in the same manner as described in Example 1, except that TiO₂ in place of YSZ was applied to the palladium catalyst by deposition.

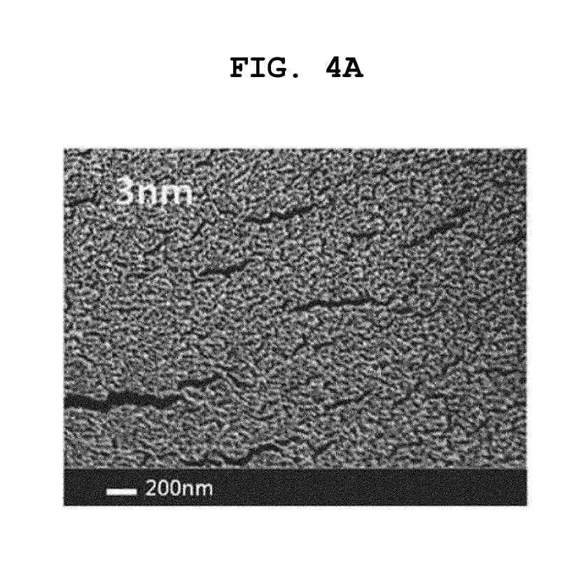

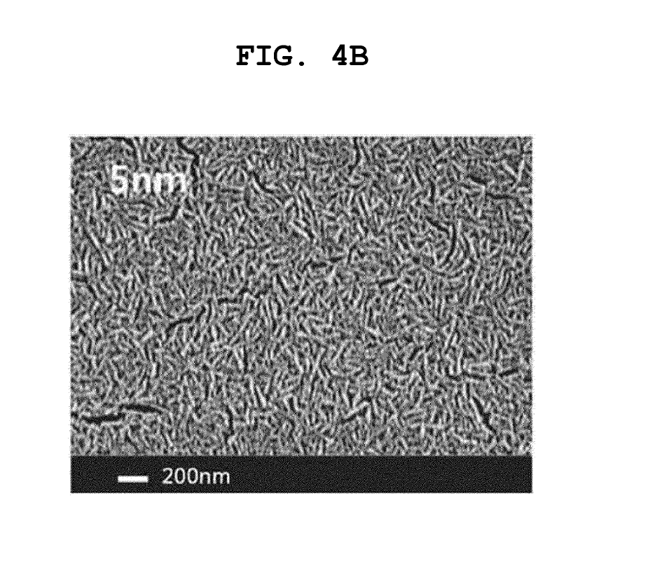

FIGS. 4A and 4B show photographs showing the oxide (YSZ) particles applied to a thickness of 3 nm (FIG. 4A) and a thickness of 5 nm (FIG. 3B) in Example 2. As can be more clearly seen therein, nanodot or core-shell structures having a uniform size were formed.

### Example 3

A composite electrode including a metal catalyst coated with oxide particles was prepared in the same manner as described in Example 1, except that SnO₂ in place of YSZ was applied to the palladium catalyst by deposition.

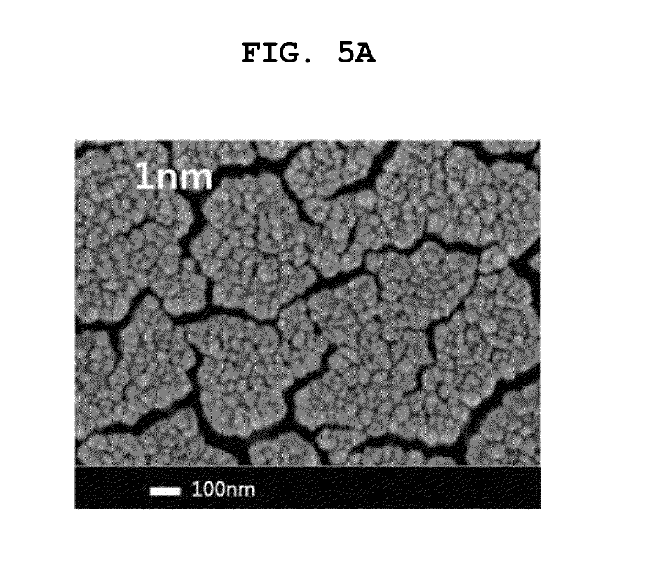

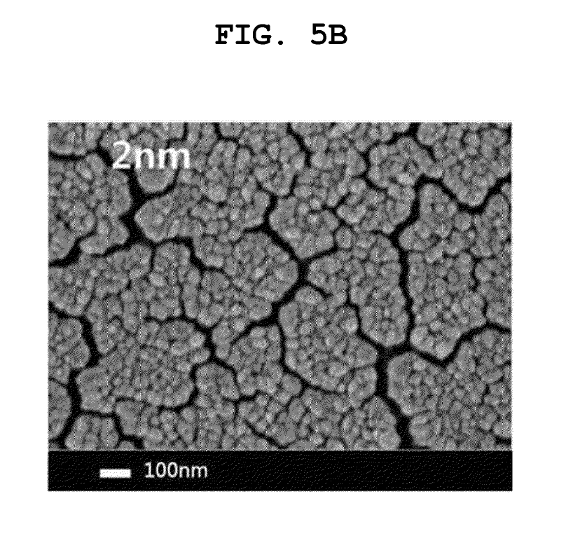

FIGS. 5A and 5B show photographs showing the oxide (YSZ) particles applied to a thickness of 1 nm (FIG. 5A) and a thickness of 2 nm (FIG. 5B) in Example 3. As can be more clearly seen therein, nanodot or core-shell structures having a uniform size were formed.

### Example 4

A composite electrode including a metal catalyst coated with oxide particles was prepared in the same manner as described in Example 1, except that a silver (Ag) catalyst was used in place of the palladium catalyst.

### Example 5

A composite electrode including a metal catalyst coated with oxide particles was prepared in the same manner as described in Example 1, except that a platinum (Pt) catalyst was used in place of the palladium catalyst.

### Comparative Examples

### Comparative Example 1

A composite electrode including an untreated palladium catalyst was used as Comparative Example 1.

### Comparative Example 2

A composite electrode was prepared in the same manner as described in Example 1, except that the process of increasing the temperature to 500° C. after deposition of zirconium and yttrium and the annealing process were not performed. Thus, the palladium catalyst in Comparative Example 2 was merely coated with YSZ, but was not coated with YSZ particles, unlike the palladium catalyst in Example 1.

### Test Examples

### Test Example 1

### Measurement of Whether Metal Catalyst Particles Agglomerated Under High-Temperature Conditions

Whether the agglomeration of the catalyst particles treated in each of the Examples and the Comparative Examples was measured. For this measurement, a fuel cell including each of the prepared composite electrodes was operated so as to be heated to 500° C., and whether the agglomeration of the catalyst particles occurred was measured.

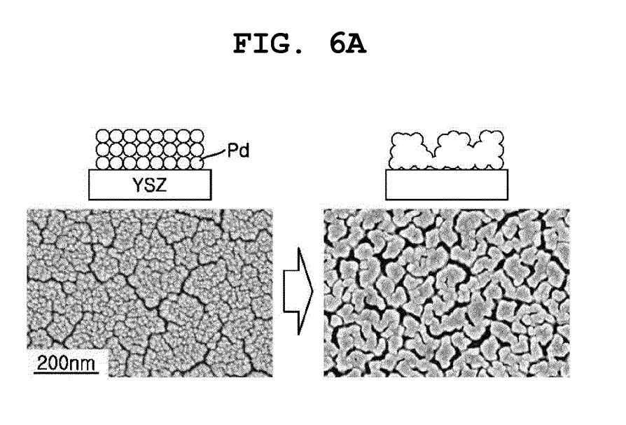

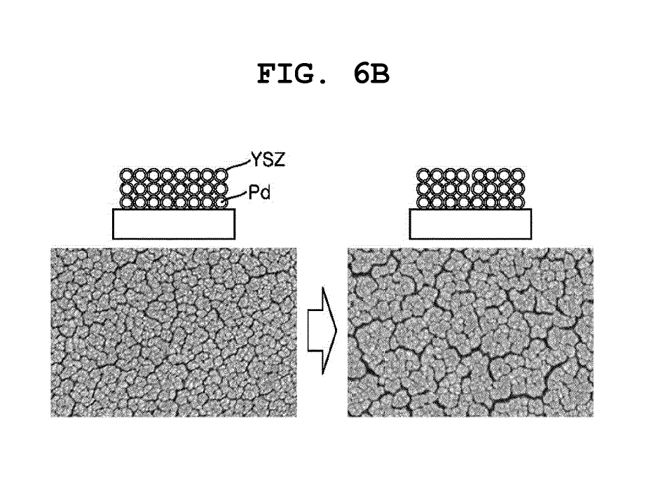

The results of the measurement are shown in FIGS. 6A and 6B. As can be seen therein, in the case of Example 1 (FIG. 6B), nanodot or core-shell structures having a uniform size were formed while agglomeration of the catalyst particles did not occur. In the case of Examples 2 to 5, it was observed that agglomeration of the catalyst particles did not occur. However, in the case of Comparative Example 1 in which only the palladium catalyst not coated with oxide particles (FIG. 6A) was used, it could be seen that severe agglomeration of the catalyst particles occurred.

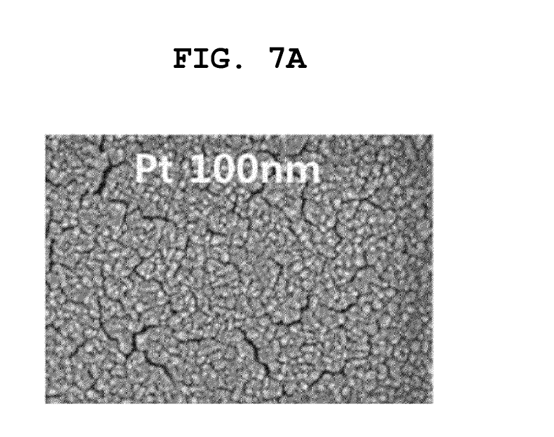

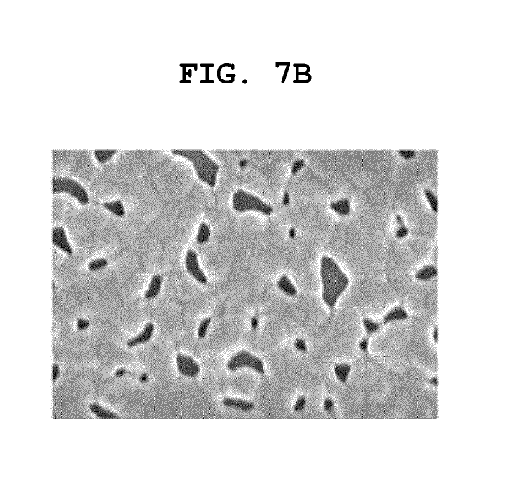

In addition, as can be seen in FIGS. 7A and 7B (FIG. 7A: before high-temperature operation of a fuel cell; and FIG. 7B: after high-temperature operation of the fuel cell), when the fuel cell including a pure platinum (Pt) catalyst not coated with oxide particles was operated under high-temperature conditions, severe agglomeration of the catalyst particles also occurred.

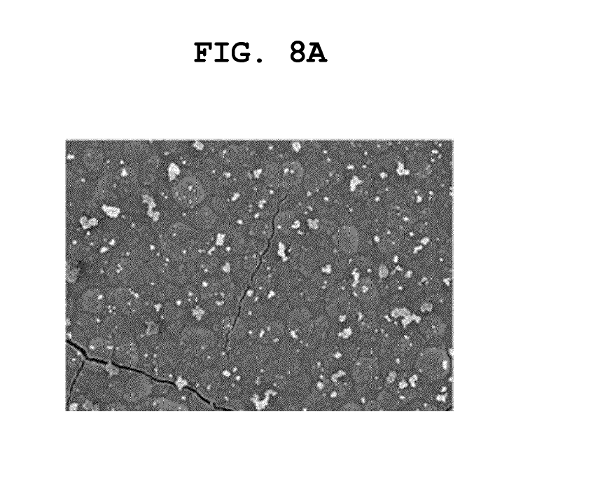

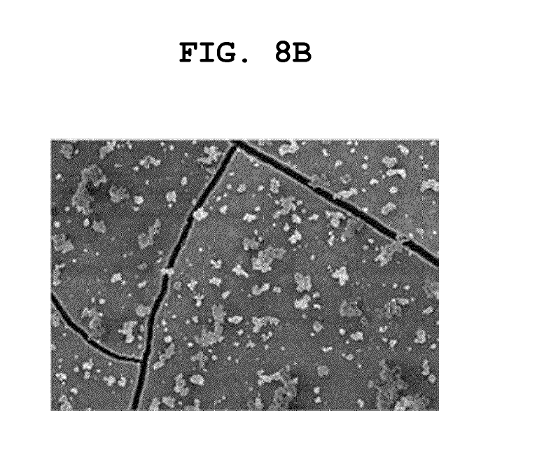

Furthermore, as can be seen in FIGS. 8A and 8B (FIG. 8A: before high-temperature operation of a fuel cell; and FIG. 8B: after high-temperature operation of the fuel cell), in the case of Comparative Example 2 in which the annealing process following the process of increasing the temperature to the high temperature was not performed, the catalyst particles severely agglomerated after operation of the fuel cells while a cracking phenomenon also occurred.

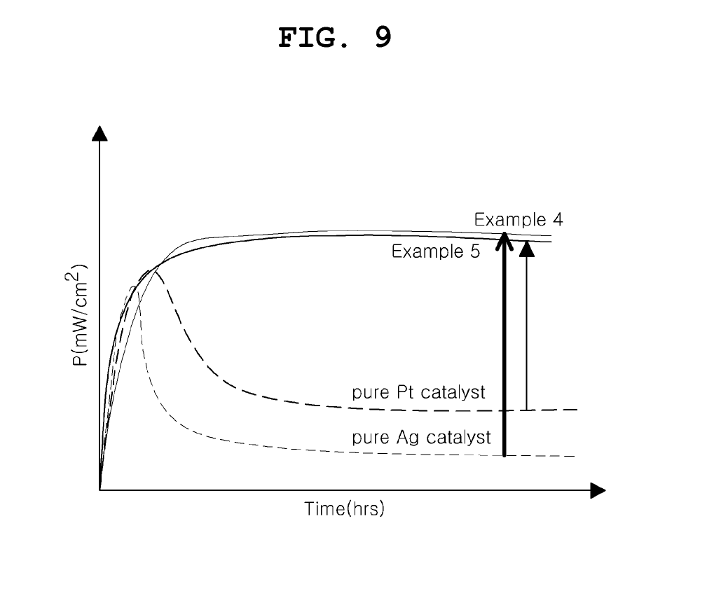

Meanwhile, in the case of Examples 1 to 5, severe agglomeration of the catalyst particles did not occur, unlike the case of Comparative Examples 1 and 2, but agglomeration of the catalyst particles in the case of Example 5 was more severe than that in the case of Examples 1 to 4, and coating with the oxide particles in Example 5 had no significant effect on improvement in other performance. As can be seen in FIG. 9 showing a comparison of improvement in performance between Example 4 and Example 5 as representative examples, improvement in performance was significantly greater in the case of Example 4 in which the Ag catalyst coated with the oxide particles, like the case of Example 1, was used, than in the case of Example 5 in which the platinum catalyst was used. In addition, it was observed that the use of Ag exhibited performance similar to that exhibited by the use of platinum. Such results suggest that the present invention overcomes the disadvantage of silver that makes it difficult to use it as an electrode material due to severe agglomeration of silver particles, even though silver is generally a good electrode material. In addition, such results indicate that the process as described in Example 1 can be applied to catalysts other than a platinum catalyst in order to solve problems that occur when the platinum catalyst is used. Examples of catalysts to which the process of Example 1 may be applied in order to overcome problems occurring in the use of the platinum catalyst include palladium, ruthenium, cobalt, iron, lithium, magnesium, copper, zinc, silver, rhodium, molybdenum, lanthanum, titanium, tin, vanadium, chromium, manganese, nickel, aluminum, antimony, arsenic, barium, bismuth, calcium, lead, mercury, silicon, tantalum, and oxides of these metals.

### Test Example 2

### Test for Comparison of Efficiencies of Composite Electrodes

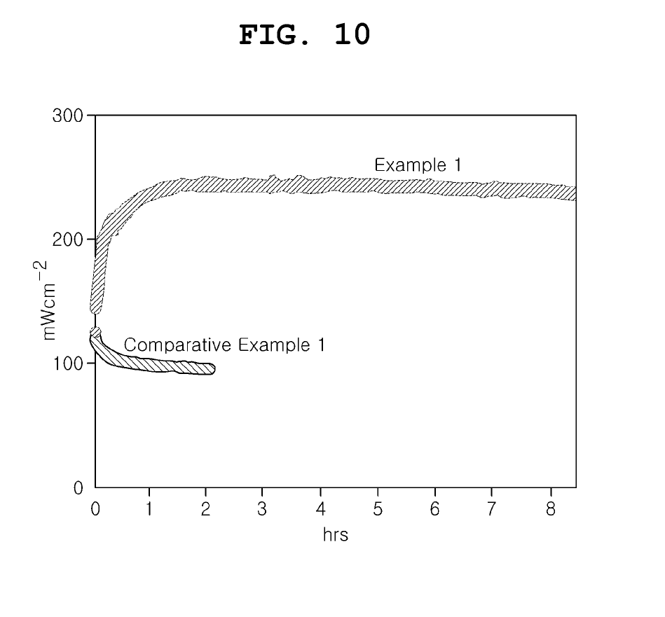

A test for comparing the performance of a cell including the composite electrode of Example 1 with the performance of a cell including the composite electrode of Comparative Example 1 was performed. The results of the test are shown in FIG. 10. As can be seen in FIG. 10, the performance of the cell was significantly higher in the case of Example 1 than in the case of Comparative Example 1. In addition, it was shown that the time during which the cell performance was maintained was longer in the case of Example 1 than in the case of Comparative Example 1.

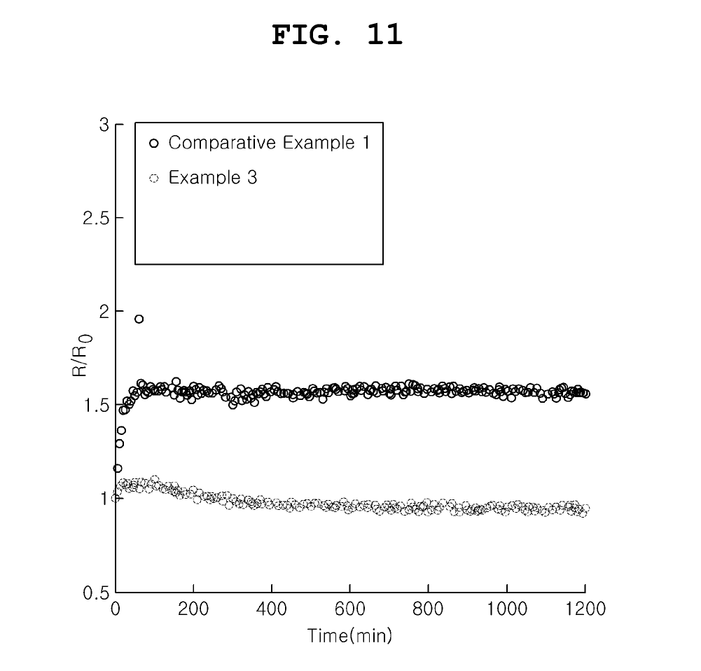

Meanwhile, FIG. 11 is a graph showing the results of measuring the sheet resistances of the composite electrodes prepared in Example 3 and Comparative Example 1. As can be seen in FIG. 11, the sheet resistance of the composite electrode of Comparative Example 1 increased. However, the composite electrode of Example 3 showed a relatively low sheet resistance, and the extent of variation in the sheet resistance of the composite electrode of Example 3 was also lower than that of the composite electrode of Comparative Example 1. In FIG. 11, the initial value of the resistance is taken as 1, and a resistance value of 1.5 means an increase in resistance of 50%.

As described above, according to the present invention, a metal catalyst is coated with an oxide, and thus particles of the metal catalyst do not agglomerate even under high-temperature conditions. Accordingly, the present invention overcomes the problem in which particles of a metal catalyst that is used in the anode or cathode of various fuel cells or in various electrode materials agglomerate when the metal catalyst particles reach high-temperature conditions during the fabrication or operation of the fuel cells, thereby reducing the efficiency of the electrode. In addition, according to the present invention, a new reaction area is formed, thereby improving performance.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A metal catalyst for a composite electrode, the metal catalyst comprising oxide particles applied thereto, wherein the oxide particles are applied so as not to overlap one another or are applied as an independent separate layer, and the oxide particles are nanograins having a diameter of 1-500 nm.

2. The metal catalyst of claim 1, wherein the oxide particles have an average particle diameter of 1-10 nm.

3. The metal catalyst of claim 1, wherein the oxide particles have a coating thickness of 1-500 nm.

4. The metal catalyst of claim 1, wherein the oxide is one or more selected from the group consisting of yttrium oxide, scandium oxide, zirconia, gadolinium oxide, samarium oxide, lanthanum oxide, ytterbium oxide, neodymium oxide, ceria, strontium oxide, magnesium oxide, lanthanum gallate, barium zirconate, barium cerate, strontium cerate, strontium zirconate, and parent perovskite.

5. The metal catalyst of claim 1, wherein a metal in the metal catalyst is one or more selected from the group consisting of palladium, ruthenium, cobalt, iron, lithium, magnesium, copper, zinc, silver, rhodium, molybdenum, lanthanum, titanium, tin, vanadium, chromium, manganese, nickel, aluminum, antimony, arsenic, barium, bismuth, calcium, lead, mercury, silicon, tantalum, and oxides of these metals.

6. A method for preparing a composite electrode, the method comprising the steps of:
1) placing an electrode substrate comprising an electrolyte within a reaction chamber, and then disposing a metal catalyst on the electrode substrate;
2) introducing a precursor of an oxide into the reaction chamber to apply the oxide to a surface of the metal catalyst by deposition;
3) increasing a temperature of the reaction chamber after step 2); and
4) annealing the oxide applied to the surface of the metal catalyst while reducing the temperature of the reaction chamber to normal temperature, thereby converting the applied oxide into oxide particles;
wherein the oxide particles are nanograins having a diameter of 1-500 nm.

7. The method of claim 6, wherein a metal in the metal catalyst is one or more selected from the group consisting of palladium, ruthenium, cobalt, iron, lithium, magnesium, copper, zinc, silver, rhodium, molybdenum, lanthanum, titanium, tin, vanadium, chromium, manganese, nickel, aluminum, antimony, arsenic, barium, bismuth, calcium, lead, mercury, silicon, tantalum, and oxides of these metals.

8. The method of claim 6, wherein a temperature of the reaction chamber in step 1) is between 150° C. and 350° C.

9. The method of claim 6, wherein the oxide applied in step 2) has a coating thickness of 1-500 nm.

10. The method of claim 6, wherein the deposition in step 2) is performed at a temperature between 150° C. and 350° C.

11. The method of claim 6, wherein the precursor of the oxide, which is introduced in step 2), is one or more selected from the group consisting of yttrium oxide, scandium oxide, zirconia, gadolinium oxide, samarium oxide, lanthanum oxide, ytterbium oxide, neodymium oxide, ceria, strontium oxide, magnesium oxide, lanthanum gallate, barium zirconate, barium cerate, strontium cerate, strontium zirconate, and parent perovskite.

12. The method of claim 6, wherein the precursor of the oxide, which is introduced in step 2), is one or more metal oxides selected from the group consisting of aluminum, antimony, arsenic, barium, bismuth, calcium, chromium, cobalt, copper, iron, lead, lithium, manganese, mercury, nickel, silicon, tantalum, tin and zinc oxides.

13. The method of claim 6, wherein the temperature that increased in step 3) is between 200° C. and 800° C.

14. The method of claim 6, wherein the temperature in step 3) is increased at a rate of 0.1 to 50° C./min.

15. The method of claim 6, further comprising a step of maintaining the temperature, which increased in step 3, for 1-50 hours.

16. A method for preparing a composite electrode, the method comprising the steps of:
1) placing an electrode substrate comprising an electrolyte within a reaction chamber, and then disposing a metal catalyst on the electrode substrate;
2) introducing a zirconium precursor into the reaction chamber to deposit zirconium on the metal catalyst;
3) introducing an yttrium precursor into the reaction chamber to deposit yttrium on the metal catalyst;
4) increasing the temperature of the reaction chamber, after performing steps 1) to 3) to apply yttrium-stabilized zirconium (YSZ) to the metal catalyst; and
5) annealing the YSZ applied to the metal catalyst while reducing a temperature of the reaction chamber to normal temperature, thereby converting the applied YSZ into YSZ particles.

17. The method of claim 16, wherein a ratio of a number of depositions in step 2 to a number of depositions in step 3) is 1:1 to 1:10 (number of depositions of zirconium: number of depositions of yttrium).

18. A composite electrode comprising a metal catalyst set forth in claim 1.

19. A fuel cell comprising a composite electrode set forth in claim 18.

20. A sensor comprising a composite electrode set forth in claim 18.
